(19) United States
(12) Patent Application Publication
(10) Pub. No.: US 2008/0217134 A1
(43) Pub. Date: Sep. 11, 2008

(54) Process for pressure actuation of a shifting element

(75) Inventors: Christian Popp, Kressbronn (DE); Klaus Steinhauser, Kressbronn (DE); Armin Gierling, Langenargen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 12/041,050

(22) Filed: Mar. 3, 2008

(30) Foreign Application Priority Data
Mar. 7, 2007 (DE) 10 2007 010 942.5

(51) Int. Cl. F16D 25/00; G06F 19/00

(52) U.S. Cl. 192/85 R; 701/68

(57) ABSTRACT

The invention concerns a process for pressure actuation of a rotating shifting element of an automatic transmission or automated manual transmission, in which the shifting element is configured with a piston that interacts with a torque transfer element and a pressure medium supply, by way of which the piston can be actuated with pressure medium in order to be displaced into a positioned defined for an activated state of the shifting element, and in which a pressure pulse can be induced in the pressure medium supply in a de-activated state of the shifting element. It is proposed that the pressure medium pulse be triggered when the pressure medium amount drained from the de-activated shifting element has reached a predefined value.

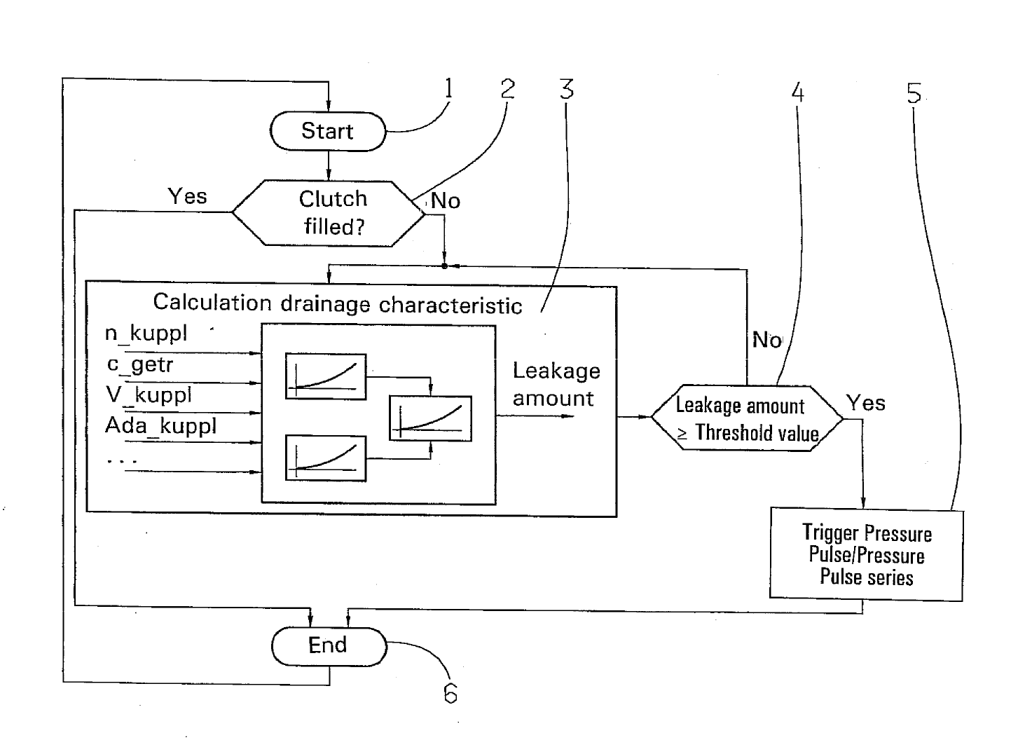

This application claims priority from German Application Serial No. 10 2007 010 942.5 filed Mar. 7, 2007.

### FIELD OF THE INVENTION

The invention concerns a process for pressure actuation of at least one rotating shifting element of an automatic transmission or automated manual transmission.

### BACKGROUND OF THE INVENTION

Automatic powershift transmissions containing planetary gearsets with clutches and brakes, which make shifting of gears under load possible, are sufficiently known from practice. In order to initiate a gear change, the friction shifting elements (clutches or brakes) are usually hydraulically actuated with pressure. Friction shifting elements configured as a disk clutch or disk brake usually have a piston which, when actuated by pressure, compresses the disk set. The shifting element can transfer the torque in a friction-locked manner induced in the shifting element. The filling of the piston chamber of the shifting element with pressure medium or the pressure actuation of its piston is usually carried out by way of electro-hydraulic pressure control valves, optionally in combination with magnetic valves.

The supply of pressure medium to the rotating shift elements is always problematic. The disk carrier, which along with the disk set of this shifting element also accommodates the piston of this shifting element and forms the piston chamber together with this piston and is mounted on a fixed transmission component (for example, on a hub fixed on the transmission housing) or on a transmission component that rotates with relative rotational speed (for example, on a shaft). The pressure medium supply to the pressure chamber of such a shifting element is usually via channels or bores in the corresponding transmission component, at or on which the disk carrier with the piston is mounted. These oil feeds to rotating friction shifting elements of known automatic transmissions, are usually sealed by way of rotating sealing rings (for example, by way of rectangular compression rings), but these sealing rings do not provide a reliable seal of the pressure medium over long periods of time.

When the clutch is not actuated for a long period of time, there is usually leaking in the oil supply. This may be disregarded, however, when a rotating shifting element is engaged after a long waiting period, because the leak depends on many factors, such as manufacturing tolerances in the respective transmission, the actual transmission oil temperature, the dwell time since last shifting of the affected shifting element, the rotational speed level at the sealing rings of the pressure medium supply of the affected shifting element since the last actuation, as well as pressure tolerances in the electro-hydraulic control device of the transmission.

In order to prevent drainage of the pressure medium supply of a rotating disk clutch in non-actuated state (prefilling) is known from practice, in which an oil supply channel of the pressure medium supply to the piston chamber of the affected shifting element is always actuated with a low minimum pressure, in order to keep the oil supply channel filled even when the affected clutch is unengaged and to compensate for the leak of the pressure medium supply. However, this prefilling has the disadvantage that a low volume of pressure medium is permanently directed into the pressure medium supply and must be constantly made available by the pressure medium pump of the transmission as permanent additional delivery volume and noticeably degrades transmission efficiency, especially when several shifting elements are prefilled. Another disadvantage of prefilling consists in the technical difficulty of carrying it out, considering all possible tolerances and the oil temperature, in such a way that the piston chamber of the affected unengaged shifting element is always full of pressure medium during the operation of the transmission, while even an unintentional forward movement of the piston of the affected shifting element at its disk set and thus an unintentional torque transfer of the affected shifting element, is securely excluded. In prefilling, there is a danger that the de-activated shifting element or its disk set will be compressed by the piston due to the pressure of the prefilling, where an unallowable gear transmission ratio can be produced at the planetary gears which as a consequence, can have at least premature wear or even failure of the shifting element or, in the worst case, even a locking of the transmission.

A control process is known from DE 197 55 064 B4 for the purpose of preventing drainage of the pressure medium supply of a rotating disk clutch in a non-actuated state in which the affected unengaged clutch is actuated by the electro-hydraulic transmission control with a time-controlled recurring pressure pulse. It is essential herein that the pressure pulse be predefined with regard to its pressure level and pulse duration. The pressure level is predefined as a fixed value. The pulse duration is predefined either as a fixed value or depending on the pressure medium temperature, such that the pulse duration then increases as the pressure medium temperature decreases. This temporary pressure medium delivery into the affected clutch, by way of a pressure pulse, is insufficient to produce a torque transfer of the affected clutch. On the other hand, it is essential in the control process of DE 197 55 064 B4 that these pressure pulses recur within a predefined time interval. In this way, the time interval between the same pressure pulses is predefined either as a fixed value or as a gear-dependent value or depending on the pressure medium temperature where, in the last case, the time interval then increases as the pressure medium temperature decreases. It is essential in the control process of DE 197 55 064 B4 that the electro-hydraulic transmission control emits the pressure pulses for the affected unengaged clutch in the same gear or at the same transmission temperature, that is, always at equidistant intervals and always with the same pulse height and pulse duration. For the sake of the advantage of comparatively simple programming and application, it is disadvantageous in the control process of DE 197 55 064 B4 that there is no compensation for the transmission tolerances, which must necessarily exist, and a compensation for temperature influences is only partially possible. The actual emptying characteristic of the affected clutch is thus not taken into consideration here, but only roughly estimated in the best case.

From DE 199 42 555 A1, a further control process for preventing drainage of the pressure medium supply of a rotating disk clutch in the non-actuated state is known. Here too the disk clutch features a piston that acts on the disk set of the clutch and a pressure medium supply such that this piston can be actuated by displacement with pressure medium into a position such that the clutch is in an activated state. In this control process as well, when the clutch is in de-activated state, a recurring pressure medium pulse is directed to the pressure medium supply, the impulse being dimensioned in such a way that the piston remains in a position defined for the de-activated state of the clutch. In contrast to DE 197 55 064 B4, in the control process of DE 199 42 555 A1, this recurring pressure medium pulse is carried out depending on the dwell time of the clutch in the de-activated state which is to be actuated with the pressure medium, especially in a cyclically recurring manner. The pressure level and pulse duration of this pressure medium pulse can be predetermined depending on the dwell time and a transmission oil temperature and/or an air gap of the clutch to be actuated with pressure medium. With regard to the pressure level and pulse duration of the pressure medium pulse, DE 199 42 555 A1 also teaches that the pressure medium pulse is preferably carried out with a pressure whose value corresponds to a fast fill pressure of the clutch to be actuated with the pressure medium pulse and that the pressure medium pulse is preferably carried out with the pressure medium pulse over a time which is somewhat less than or equal to a fast fill time of the clutch to be actuated. This control process does indeed better compensate for leakage losses at a switched-off shifting element than do the control process, according to DE 197 55 064 B4, and improves the filling characteristic of this switched-off shifting element with respect to the control process, according to DE 197 55 064 B4, but the control process, according to DE 199 42 555 A1, also fails to sufficiently allow for the actual draining characteristic of the affected shifting element.

Based on this, it is the object of the invention to provide a process for pressure actuation of a rotating shifting element of an automatic transmission or an automated manual transmission, especially of a motor vehicle, with which the filling characteristic of a switched-off shifting element can be further improved with regard to a leakage prevention and the reproducibility of a good shifting quality.

### SUMMARY OF THE INVENTION

The invention is based on the fact that, especially in a rotating shifting element of an automatic or automated transmission of any type, even in an unengaged state some leakage occurs in the area of the then still partially oil-filled piston chamber of this shifting element and in the area of the then still unpressurized oil-filled pressure medium supply to this piston chamber. This leakage in the unengaged state of the shifting element has, in turn, a negative influence on the shifting quality when the shifting element is subsequently re-engaged, since the current actually required filling amount of the piston chamber of the shifting element at the start of shifting also includes the leakage amount that was drained during the unengaged state of the shifting element, but is not exactly known. The invention is also based on the realization that the amount of leakage, which occurs during the unengaged state of the shifting element and must be compensated for when the piston chamber of the shifting element is refilled, depends not only on how long the affected shifting element was switched off or de-activated before activation.

A process for pressure actuation of a rotating shifting element of an automatic transmission or automated manual transmission, especially for motor vehicles, is proposed in which the shifting element is configured with a piston that interacts with torque transfer elements and a pressure medium supply, such that the piston can be actuated with pressure medium in order to displace it into a position defined for an activated state of the shifting element and in which a pressure pulse can be directed into the pressure medium supply in a de-activated state of the shifting element where, according to the invention, the pressure medium pulse is triggered when the pressure medium amount flowing from the de-activated shifting element reaches a predefined value.

This predefined value is preferably dimensioned in such a way that the piston remains, at least for the most part, in a position defined for the de-activated state of the shifting element and a piston chamber of the shifting element, which is defined by the position of the piston when the shifting element is de-activated, remains at least partially filled with pressure medium.

In a preferred embodiment, the pressure medium amount that flows out of the de-activated shifting element is then determined by way of a theoretical model, which represents the actual drainage characteristic of the shifting element and its pressure medium supply.

As an essential improvement over the state of the art from which a purely time-controlled recurring pressure medium pulse for the activation of a de-activated or unengaged shifting element of an automatic transmission is known, the event-controlled pressure medium pulse for activation of a de-activated or unengaged shifting element allows very precise adaptation to real conditions of the affected shifting element. According to the invention, the pressure pulse by which the de-activated shifting element, is temporarily actuated is triggered exactly when the corresponding shifting element, according to the model calculation, has drained to the extent that compensation for this leakage amount is necessary in the pressure medium supply and piston chamber of the shifting element in order to ensure a reproducible equal initial situation for the pressure actuation of this shifting element for a subsequent engagement procedure of this shifting element within the scope of gear changing. In this way, the shifting quality is clearly improved. The person skilled in the art can clearly see that the result is better the more accurate the utilized model reflects the actual drainage characteristic of the rotating shifting element, including its pressure medium supply, which is still filled with pressure medium even in de-activated state.

A multitude of influencing variables, which influence the pressure medium or leakage amount actually being drained from the de-activated shifting element, can then be taken into consideration within the scope of this model. For example, the pressure medium or leakage amount, determined by way of the model, can be a function of one or several of the following parameters:
the dwell time of the shifting element in de-activated state;
a temperature, especially the pressure medium temperature or the transmission temperature;
a temperature collective with which the shifting element or the transmission is operated during the dwell time of the shifting element in de-activated state;
the pressure medium type used in the transmission and its viscosity or viscosity characteristic;
a rotational speed, especially a rotational speed of the shifting element, such as the shifting element input speed or the rotational speed of that shifting element component, which displaceably accommodates the piston of the shifting element and forms the piston chamber of the shifting element that can be filled with pressure medium;
a rotational speed collective with which the shifting element or the shifting element component, which displaceably accommodates the piston of the shifting element and a piston chamber of the shifting element that can be filled with pressure medium, can be operated during the dwell time of the shifting element in the de-activated state;
a current position tolerance of the shifting element determined from the filling parameters of pressure actuation of the shifting element when the shifting element is activated or engaged, especially from current adapted values of a fast fill pressure and/or a fast fill time of the pressure actuation of the shifting element, and
an actual total transmission runtime as an indicator of the wear and hence increased leakage.

As an alternative to mathematical determination of the theoretical pressure medium amount drained from the de-activated shifting element by way of a model, it can also be provided that the pressure medium amount drained from the de-activated shifting element can be obtained by way of a measurement.

In a further embodiment of the invention, it is provided that the predefined value for the pressure medium amount drained from the de-activated shifting element which, when reached, triggers the pressure medium pulse is stored in an electronic control device of the transmission as a value specific to the shifting element. In this way, specific design features of different shifting elements of the transmission, which are all to be temporarily actuated in de-activated state (that is, unengaged) with a pressure medium pulse, can be easily taken into consideration.

Based on its effect, the pressure medium pulse, which is triggered, in a manner according to this invention, actuates the piston of the corresponding shifting element in de-activated state (that is, unengaged) of the shifting element, is preferably measured in such a way that the leakage amount drained in the de-activated state of the shifting element from its piston chamber and pressure medium supply is compensated for as much as possible so that the piston of the shifting element remains, at least for the most part, in a position defined for the de-activated state of the shifting element and the piston chamber of the shifting element, which is defined by way of the position of the piston in the de-activated state of the shifting element, remains filled at least for the most part with pressure medium.

As a further embodiment of the invention, it is proposed that the duration and/or pressure level of the pressure medium pulse, triggered according to the invention, is a function of a temperature, especially a function of the current pressure medium temperature or the current transmission temperature. The duration and/or pressure level of the pressure medium pulse, triggered according to the invention, however, also can be a function of a rotational speed, especially a function of a current transmission input speed, a current shifting element input speed or a rotational speed of a shifting element component, which displaceably accommodates the piston of the shifting element and forms a piston chamber of the shifting element that can be filled with pressure medium. These embodiments allow high accuracy in compensating for the leakage amount of the corresponding shifting element drained in the de-activated or unengaged state.

In the simplest case, the pressure medium pulse triggered according to the invention is configured as a single pressure pulse. This always suggests itself especially when even a short pressure medium pulse is sufficient, with comparatively high probability, to sufficiently refill the draining piston chamber of the shifting element so that a reproducible uniform initial filling state of the corresponding shifting element can be achieved for a subsequent shifting in which the shifting element actuated with the pressure medium pulse is to be activated.

As an alternative to this, however, it can be provided that the pressure medium pulse, triggered according to the invention, be emitted or carried out as a sequence of several individual rapidly repeated pressure pulses. In this way, the accuracy of the leakage amount compensation for the non-actuated shifting element can again be increased or improved.

Accordingly, as a further development of the invention, it is proposed that the pressure medium pulse, triggered according to the invention, is implemented as a time sequence of several individual pressure pulses with equi-distant time intervals. As alternative to this, the pressure medium, triggered according to the invention, can be implemented as a time sequence of several individual pressure pulses with variable time intervals.

In a further development of the invention, it is proposed that the pressure medium pulse, triggered according to the invention, be implemented as a time sequence of several individual pressure pulses with the same pressure level. As an alternative to this, the pressure medium pulse, triggered according to the invention, can be configured as a time sequence of several individual pressure pulses with variable pressure level.

### BRIEF DESCRIPTION OF THE DRAWING

The invention will now be described, by way of example, with reference to the accompanying drawing in which:

The sole FIGURE represents a simplified functional sequence for an exemplary process, according to the invention, which is a component of an electronic transmission control.

### DETAILED DESCRIPTION OF THE INVENTION

A first program step 1, the function is started. A second program step 2 tests to see if a disk clutch, which is to be actuated in the de-activated state, if needed, with a pressure medium pulse for leakage compensation outside of a gear shifting, is currently filled with pressure medium. The piston chamber of the clutch is always filled with pressure medium when the latter is activated (that is, engaged and transferring torque). The piston chamber of the clutch can, however, also be filled with pressure medium in the de-activated state (that is, unengaged and not transferring torque) by maintaining a defined low pressure in the piston chamber, which is known from the state of the art as prefilling, and serves to keep the piston of the de-activated (that is, not transferring torque) clutch in a piston position close to the disk set of the clutch in order to shorten the reaction time between the shifting command and actual torque transfer during a subsequent engagement of the clutch. If the clutch is currently filled in program step 2, the functional sequence is continued with program step 6, which designates the end of the function. The function is then restarted with program step 1. On the other hand, if the clutch is not filled in program step 2, the functional sequence is continued with program step 3.

Program step 3 comprises a complex computation model in which the leakage amount, which is drained from the piston chamber or the pressure medium supply to the piston chamber of the de-activated clutch, is determined based on a multitude of current and stationary parameters. A model in which the clutch, including its pressure medium supply, is mathematically simulated, is the basis for calculation of the drainage characteristic of the clutch. A rotational speed n_kuppl, a temperature c_getr, a volume V_kuppl and an adaptation variable Ada_kuppi are mentioned as Input variables for the calculation in the exemplary embodiment. However, it is also suggested that further input variables can be provided for the calculation. For logical reasons, the input variable n_kuppl is a current measured rotational speed, which is equivalent to the actual clutch input speed or to that actual rotational speed with which the piston chamber of the clutch rotates. Here the rotational speed n_kuppl can be incorporated as an absolute value, as well as mathematically added as a rotational speed collective to the calculation of the leakage amount. The input variable c_getr is advisably a current measured temperature, which is equivalent to the actual pressure medium temperature. The temperature c_getr can be incorporated both as an absolute variable as well as mathematically added as a temperature collective in the calculation of the leakage amount. Of course, the type and viscosity characteristic of the utilized pressure medium can be taken into consideration. The input variable V_kuppl is a stationary clutch-specific characteristic quantity equivalent to the constructively predetermined fill volume of the piston chamber, preferably taking into consideration the pressure medium supply to the piston chamber. The input variable Ada_kuppl is a collective term for all current parameters of pressure actuation of the clutch, which provide information concerning the filling and emptying characteristic of the piston chamber of the clutch and are constantly adapted within the scope of activation and de-activation of the clutch during gear change in the electronic transmission control device.

The output variable of the calculation model in program step 3 is a current value for that leakage amount which has already been drained since the time of de-activation (cut-off or disengagement) of the clutch or since the time of termination of the pressure medium pulse. The functional sequence is continued with program step 4, which checks to see if the leakage amount determined previously in program step 3 has reached or exceeded a predetermined threshold value. If this is not the case, the function is continued by returning to program step 3. But if the leakage amount determined in program step 3 has reached or exceeded the predefined threshold value, the function is continued with program step 5 in which the piston of the clutch is actuated with the provided pressure medium pulse.

In program step 4 is not shown in detail that the predefined threshold value can be a constant as well as a variable dependent on numerous parameters, which is stored in the electronic transmission control device. Consequently the mentioned threshold value can be a function of one or several of the following parameters:
a current transmission input speed;
a current shifting element speed;
a current transmission output speed;
a current vehicle speed;
a current actual gear of the transmission;
a possible target gear of the transmission;
a current shift mode of the transmission, such as a sport shift program or an economy shift program;
a transmission temperature;
a pressure medium temperature;
a pressure medium type;
a pressure medium viscosity;
a current tolerance situation of the shifting element;
an especially adapted fast fill pressure of a fast fill phase of pressure actuation of the shifting element used for engaging the shifting element;
an especially adapted fast fill time of the fast fill phase of the pressure actuation of the shift element used for engaging the shifting element;
an especially adapted fill pressure of the fill compensation phase of the pressure actuation of the shift element used for engaging the shifting element;
an especially adapted fill time of the fill compensation phase of the pressure actuation of the shift element used for engaging the shifting element, and
a current total transmission runtime.

In program step 5, as already mentioned, the piston of the clutch is charged with the provided pressure medium pulse. To this extent, program step 5 can also be termed an output module. As a specific feature, in program step 5, it is provided that the pressure medium pulse is configured either as an individual pressure pulse or else as a pressure pulse series, depending on the current requirement.

The exemplary embodiment provides that, with regard to the dimensioning of the pressure medium pulse, when a single pressure pulse is not sufficient to resupply the calculated or actually drained leakage amount with sufficiently high accuracy to the de-activated shifting element, the de-activated shifting element and/or its piston is charged within a short interval after the first pressure pulse with at least one further pressure pulse. The interval, between these individual pressure pulses, can be calculated or predefined using the model simulation of the emptying characteristic of the corresponding shifting elements. For this purpose, the data that are continuously refreshed for this shifting element within the shifting control and are simulated during filling (switching on or activation) and emptying (switching off or de-activation) of this shifting element in a theoretical piston chamber model or piston position model, which provides reliable information concerning the current actual filling characteristic of the piston chamber of the shifting element. In this way, the pressure level and duration of the individual pressure pulses can be optimally tailored to the respective current state of the corresponding shifting element and an at least largely complete leakage compensation can be ensured without the pressure medium pulse causing an accidental and undesirable short-term torque transfer to the de-activated shifting element.

At this point, possible calculation methods for the pressure level and duration of the pressure medium pulse in program step 5 should be addressed in more detail. By way of the process according to the invention, advantageously the leakage amount that is to be resupplied to the piston chamber and to the pressure medium supply of the de-activated shifting element by way of a pressure medium pulse is precisely known. It can thus also be advantageously provided that the pressure level and/or duration of the pressure medium pulse be directly derived from the value determined previously in program step 3 for the pressure medium amount drained from the de-activated shifting element such that very effective and precise leakage compensation is achieved.

As an alternative or in addition to this, it can be provided that, in program step 5, the pressure level and/or duration of the pressure medium pulse is derived from filling parameters of a pressure actuation utilized for engaging the shifting element, especially from current adapted values of a fast fill pressure and/or a fast fill time and/or a fill pressure and/or a fill time of pressure actuation of the shifting element. In this way, the current position tolerance of the shifting element is especially taken into consideration, especially in order to prevent an unintentional overcompensation of the actual leakage amount and therewith an undesirable (even though small) torque transfer by way of the actually de-activated shifting element.

For example, the pressure level and/or duration of the pressure medium pulse can then be a function of the temperature, especially a function of the current pressure medium temperature or the current transmission temperature. The pressure level and/or duration of the pressure medium pulse can also be a function of a rotational speed then, especially a function of a current transmission input speed or a current shifting element input speed or the rotational speed of the shifting element component, which displaceably accommodates the piston of the shifting element and forms the piston chamber of the shifting element, which can be filled with pressure medium.

The pressure level and/or duration of the pressure medium pulse can also be a function of the actual current supply rate of the pressure medium pump of the transmission and/or also a function of the actual current system pressure of the transmission.

Further impetus for calculation of the pressure level and/or duration of the pressure medium pulse can be found by the person skilled in the art, for example in the initially cited DE 199 42 555 A1, and also in the process for normal pressure actuation of a shifting element during activation or gear change. Thus the person skilled in the art must not necessarily configure the pressure medium pulse as a square pulse but, if necessary, pressure ramps or analytic pressure and time functions can be provided.

If the pressure medium pulse, triggered according to the invention, in program step 5, is implemented as a pressure pulse series, then further possibilities or degrees of freedom are made available with regard to the pressure level, duration and interval of the individual pressure pulses of the pressure pulse series. In this way, as the simplest variation of the specification and implementation of the time interval, between the individual pressure pulses of a pressure pulse series, in program step 5, it is provided that the pressure medium be configured as a time sequence of several individual pressure pulses with equidistant time intervals. In a more complex variation, however, the pressure medium pulse can also be predetermined or configured, however, with variable time intervals as a time sequence of several individual pressure pulses. In this case, it can be provided that the interval, between the individual pressure pulses, is continuously reduced with each further individual pressure pulse so that the interval, between the last two individual pressure pulses is shorter than the distance between the first two individual pressure pulses. This becomes clear from a simple numeric example for a pressure medium pulse consisting of three individual pressure pulses: while the second individual pressure pulse follows 100 ms after the end of the first individual pressure pulse, the third individual pressure pulse follows, just 60 ms after the end of the second individual pressure pulse.

Further impetus for calculation of the time interval between, the individual pressure pulses, can be found by the person skilled in the art in DE 197 55 064 B4 mentioned above.

With regard to specification and implementation of the pressure level of the individual pressure pulses of a pressure pulse series, the simplest variation can be to provide all of the individual pressure pulses of this time sequence with the same pressure level. In a more complex variation, however, the pressure medium pulse can also be predetermined or configured as a time sequence of several individual pressure pulses with variable pressure level. In this case, it can be provided that the pressure level of the individual pressure pulses continuously decreases with each further individual pressure pulse so that the pressure level of the last individual pressure pulse is lower than the pressure level of the first individual pressure pulse. This becomes clear in a simple numerical example for a pressure medium pulse consisting of three individual pulses: the first individual pressure pulse occurs is at 4 bar, then the second individual pressure pulse is at 3 bar and the third pressure pulse is at only 1 bar.

With regard to the specification and implementation of the pulse length of the individual pressure pulses of a pressure pulse series, the simplest variation can be to provide all of the individual pressure pulses of this time sequence with the same pulse length. In a more complex variation, however, the pressure medium pulse can also be predetermined or configured as a time sequence of several individual pressure pulses with variable pulse length. In this case, it can be provided that the pulse length of the individual pressure pulses continuously decreases with each further individual pressure pulse so that the pulse length of the last individual pressure pulse is shorter than the pulse length of the first individual pressure pulse. This becomes clear in a simple numerical example for a pressure medium pulse consisting of three individual pulses: the pulse length of the first individual pressure pulse is 150 ms, the pulse length of the second individual pressure pulse is 80 ms and the pulse length of the third individual pressure pulse is only 40 ms.

Of course, the person skilled in the art will combine, if need be, the mentioned exemplary processes of calculating or specifying the pressure level, pulse length and time interval of the individual pressure pulses. Likewise, the person skilled in the art will not necessarily configure the individual pressure pulses as square pulses but, if need be, will also provide pressure ramps or analytic pressure and time functions.

Going back to the functional sequence represented in the FIGURE, the function at program step 6, after program step 5 is completed, is terminated and is then started anew after returning to program step 1.

### REFERENCE NUMERALS

1 Program step, program start
2 Program step, query
3 Program step, computation model
4 Program step, query
5 Program step, output model
6 Program step, program end
Ada_kuppl Adaptation variable of pressure actuation
c_getr Temperature, transmission temperature
n_kuppl Rotational speed, clutch speed
V_kuppl Volume, fill volume of clutch

1-32. (canceled)

33. A process for pressure actuation of a shifting element, of one of an automatic transmission and an automated manual transmission of a motor vehicle, in which the shifting element is configured with a piston interacting with a torque transfer element, the method comprising the steps of:
actuating and displacing the piston with a pressure medium, supplied by a pressure medium supply, into an activated state of the shifting element, and
in a de-activated state of the shifting element, trigger a pressure medium pulse, which is induced in the pressure medium supply, when an amount of pressure medium, drained from the shifting element in the de-activated state, reaches a predefined value.

34. The process of claim 33, further comprising the step of defining the predefined value and the pressure medium pulse such that the piston remains at least substantially in a position defined for the de-activated state of the shifting element, and that a piston chamber of the shifting element, which is defined by the position of the piston in the de-activated state of the shifting element, remains at least substantially filled with pressure medium.

35. The process of claim 33, further comprising the step of determining the pressure medium amount drained from the de-activated shifting element with a theoretical model which simulates an actual drainage characteristic of the shifting element and the pressure medium supply.

36. The process of claim 35, further comprising the step of using at least one of the following parameters as a function for determining the pressure medium amount:
a dwell time of the shifting element in the de-activated state;
one of a pressure medium temperature and a transmission temperature;
a collected temperature, with which one of the shifting element and the transmission is operated during the dwell time of the shifting element in the de-activated state;
at least one of a type, a viscosity and a viscosity characteristic of a pressure medium flowing within in the transmission;
one of a rotational speed of the shifting element and a shifting element component, which displaceably accommodates the piston of the shifting element and forms a piston chamber of the shifting element to be filled with the pressure medium;
a collected rotational speed with which the one of the shifting element and the shifting element component, which displaceably accommodates the piston of the shifting element, and the piston chamber of the shifting element to be filled with pressure medium, is operated during the dwell time of the shifting element in the de-activated state;
a current position tolerance ofthe shifting element, determined from filling parameters of pressure actuation of the shifting element when the shifting element is engaged, especially from current adapted values of at least one of a fast fill pressure and a fill time of the pressure actuation of the shifting element; and
an actual total transmission runtime.

37. The process of claim 33, further comprising the step of determining the amount of the pressure medium drained from the de-activated shifting element by a measurement.

38. The process of claim 33, further comprising the step of storing the amount of the pressure medium drained from the de-activated shifting element as a value specific to the shifting element in a manner of a constant in an electronic control device of the transmission.

39. The process of claim 33, further comprising the step of storing, in an electronic control device of the transmission, the predefined value as value specific to the shifting element as a variable which is a function of at least one of the following parameters:
a current transmission input speed;
a current shifting element speed;
a current transmission output speed;
a current vehicle speed;
a current actual gear of the transmission;
a possible target gear of the transmission;
a current shift mode of the transmission;
a transmission temperature;
a pressure medium temperature;
a pressure medium type;
a pressure medium viscosity;
a position tolerance of the switching element;
an especially adapted fast fill pressure of a fast fill phase of the pressure actuation of the shifting element used for engaging the shifting element;
an especially adapted fast fill time of the fast fill phase of the pressure actuation of the shift element used for engaging the shifting element;
an especially adapted fill pressure of a fill compensation phase of the pressure actuation of the shift element used for engaging the shifting element;
an especially adapted fill time of the fill compensation phase of the pressure actuation of the shift element used for engaging the shifting element; and
a current total transmission runtime.

40. The process of claim 33, further comprising the step of deriving at least one of a pressure level and a duration of the pressure medium pulse from at least one of the following parameters:
a determined value of the amount of pressure medium drained from the de-activated shifting element;
at least one of filling parameters of pressure actuation utilized to engage the shifting element, current adapted values of a fast fill pressure, a fast fill time, a fill pressure and a fill time of the pressure actuation of the shifting element;
one of a current pressure medium temperature and a current transmission temperature;
one of a rotational speed, a current transmission input speed, a current shifting element input speed and the rotational speed of the shifting element component which displaceably accommodates the piston of the shifting element and forms a piston chamber of the shifting element that is filled with pressure medium;
a current supply rate of a pressure medium pump of the transmission; and
a current system pressure of the transmission.

41. The process of claim 33, further comprising the step of configuring the pressure medium pulse as a time sequence of several individual pressure pulses with equidistant time intervals.

42. The process of claim 33, further comprising the step of configuring the pressure medium pulse as a time sequence of several individual pressure pulses with variable time intervals.

43. The process of claim 42, further comprising the step of continuously decreasing the interval between the individual pressure pulses with each further individual pressure pulse so that the interval between a last two individual pressure pulses is shorter than the interval between a first two individual pressure pulses.

44. The process of claim 33, further comprising the step of configuring the pressure medium pulse as a time sequence of several individual pressure pulses with substantially a same pressure level.

45. The process of claim 33, further comprising the step of configuring the pressure medium pulse as a time sequence of several individual pressure pulses with variable pressure levels.

46. The process of claim 45, further comprising the step of continuously decreasing the pressure level of the individual pressure pulses with each further individual pressure pulse so that a pressure level of a last individual pressure pulse is lower than a pressure level of a first individual pressure pulse.

47. The process of claim 33, further comprising the step of configuring the pressure medium pulse as a time sequence of several individual pressure pulses having a same pulse length.

48. The process of claim 33, further comprising the step of configuring the pressure medium pulse as a time sequence of several individual pressure pulses with variable pulse lengths.

49. The process of claim 48, further comprising the step of continuously decreasing the pulse length of the individual pressure pulses with each further individual pressure pulse so that a pulse length of a last individual pressure pulse is shorter than a pulse length of a first individual pressure pulse.

50. The process of claim 33, further comprising the step of configuring the pressure medium pulse as an individual pressure pulse.

51. A process for actuating a shifting element in a transmission a motor vehicle with a pressurized medium, the process comprising the steps of:
determining an amount of the pressurized medium within a piston chamber of the shifting element, and the piston chamber communicating with a supply of the pressure medium and includes a piston communicating with a torque transfer element;
calculating an amount of the pressurized medium which leaks from the piston chamber from a previous activation of the shifting element which is defined as the amount of leaked pressurized medium;
comparing the amount of leaked pressurized medium with a threshold amount and:
if the amount of leaked pressurized medium is greater than or equal to the a threshold amount and repeating the calculating step; and
if the leakage amount is less than the threshold amount, supplying at least one pressure medium pulse to fill the shifting element while still maintaining the shifting element in a deactivated state.
